(19) United States
(12) Patent Application Publication
(10) Pub. No.: US 2005/0154816 A1
(43) Pub. Date: Jul. 14, 2005

(54) Independent base of a tablet computer

(75) Inventor: Ming Yuan Liu, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/754,722

(22) Filed: Jan. 12, 2004

(51) Int. Cl. G06F 13/00

(52) U.S. Cl. 710/303

(57) ABSTRACT

An independent base of a tablet computer comprising an enclosure and a USB hub. The USB hub comprises a driver port and a plurality numbers of peripheral ports, wherein the driver port is disposed on the enclosure and the peripheral ports are connected to various driver interfaces of the base through cables for connecting with different peripheral devices within the enclosure. Such arrangement enables a computer to be connected to the base via the driver port and utilize the peripheral devices within the enclosure via the corresponding peripheral ports.

### BACKGROUND OF THE INVENTION

I. Field of the Invention

This invention relates generally to a base of a tablet computer and, more specifically, to an independent base of a tablet computer that will not become idle and useless when the tablet computer is separated, the base functions as a peripheral hub for other computers to access.

II. Description of the Prior Art

Heretofore, it is known that electronic technology advances, all the information in the computer technology era are transferred rapidly, the quantity of all the information grow fast; in ordinary life, people rely on computers to process and exchange mass information, computers become one of the necessary important instruments, the high-tech electronic industry grows at an unpredictable pace.

By the demand of convenience of people, the tablet computers and notebook computers with easy to carry and operate for people need to process mass information is the best choice. There are many electronic devices with large number of potential consumers, how to offer more functions and convenience under current devices becomes the common desire and expectation of most of the computer users. Current tablet computers have a base with keyboard, hard disk drive, CD ROM, floppy drive, when the tablet computer is connected to the base, it becomes a complete notebook computer, users apply keyboard to input data or instructions and apply hard disk drive to access data; when the tablet computer is away from the base, users can apply input pen on the screen to input data or instructions, however after the tablet computer is away from the base, the base becomes idle and useless.

### SUMMARY OF THE INVENTION

The present invention improves the deficiency of the tablet computers set forth, while the tablet computer is away from the base, the base becomes idle and useless.

It is therefore a primary object of the invention to provide an independent base of a tablet computer comprising an enclosure and a USB hub inside the base; the USB hub contains a driver port and a plurality of peripheral ports, the driver port is disposed on the enclosure of the base, the peripheral ports are connected to various driver interfaces of the base through cables, the driver interfaces are then connected to different peripheral devices (such as: hard disk drive, CD ROM, floppy disk drive . . . ) within the enclosure; such arrangement enables a computer (a desk top computer or a notebook computer) to be connected to the driver port of the base through a USB cable, and to utilize the peripheral devices within the enclosure via the corresponding peripheral ports. Therefore, while the base is separated from the tablet computer, it will not become idle and useless and acts as a peripheral hub.

It is still an objective of this invention to provide an independent base of a tablet computer in which the USB hub consists a controller and a Repeater, the controller controls the protocol communication between the driver port and the peripheral ports, provides signals supporting hardware configuration, suspension and installation, and offers interface registers for communicating with the computer. The USB hub offers status and control instruction for the computer to manipulate and monitor all ports (driver port and peripheral ports).

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a block diagram of the present invention.

### DESCRIPTION OF THE PREFERRED EMBODIMENT

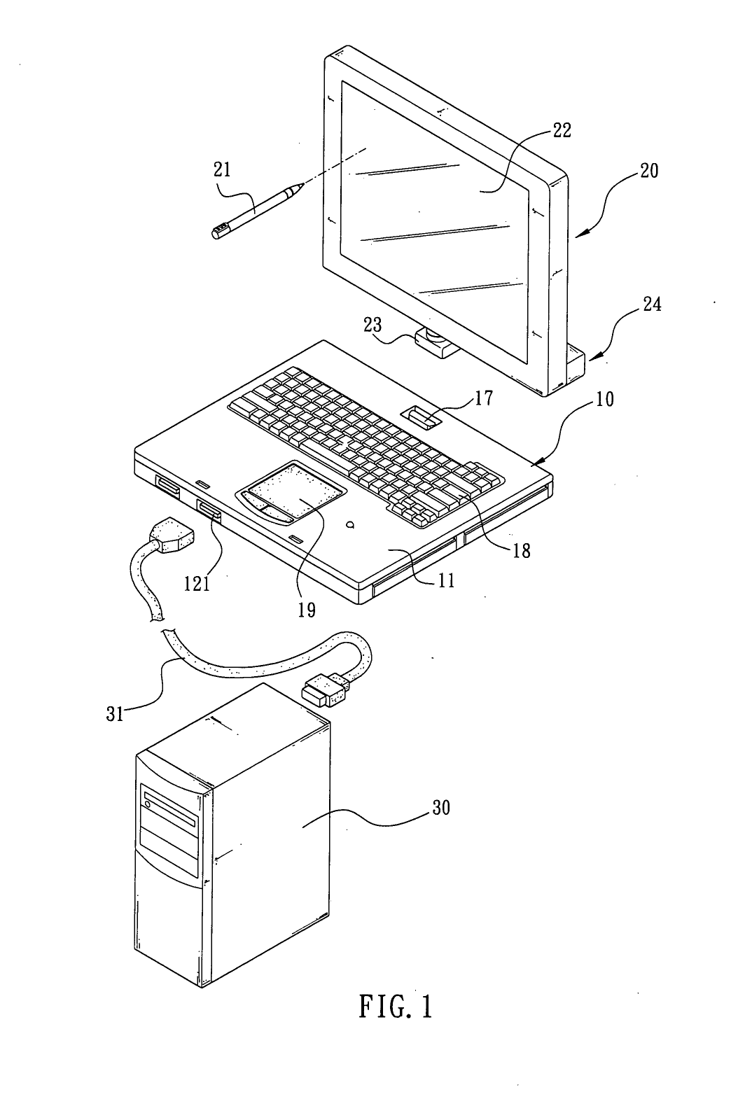

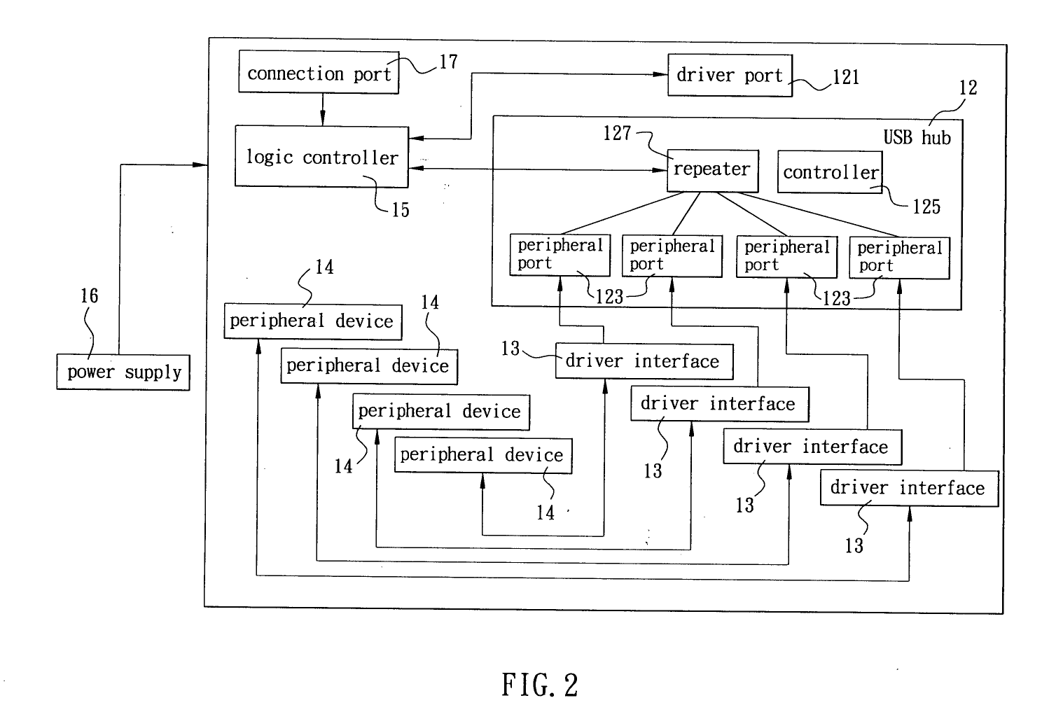

Referring to FIG. 1 and FIG. 2, the base 10 of the present invention has an enclosure 11, a USB hub is disposed inside the base 10, the USB hub 12 contains a driver port 121 and a plurality of peripheral ports 123, the driver port 121 is disposed on the enclosure 11 of the base 10, the peripheral ports 123 are connected to various driver interfaces 13 of the base 10 through cables, the driver interfaces 13 are connected to different peripheral devices 14 (such as hard disk drive, CD ROM, floppy disk drive . . . etc.) disposed within the enclosure 11; such arrangement enables a computer 30 (desk top computer, notebook computer . . . etc.) to be connected to the driver port 121 of the base 10 through a USB cable 31, and to utilize the peripheral devices 14 within the enclosure 11 via the corresponding peripheral ports 123.

Referring to FIG. 1 and FIG. 2, the USB hub 12 consists a controller 125 and a Repeater 127, the controller 125 controls the protocol communication between the driver port 121 and the peripheral port 123, provides signals supporting the hardware configuration, suspension and installation, and offers interface registers for communicating with the computer 30. Besides, the USB hub 12 offers status and control instruction for the computer 30 to manipulate and monitor all ports thereof (driver port 121 and peripheral port 123).

Referring to FIG. 1 and FIG. 2 again, the base 10 further consists of a logic controller 15, a power supply 16 and a connection port 17 connected to a tablet computer 20, wherein the logic controller 15 respectively links to the driver port 121, the Repeater 127 and the connection port 17; the logic controller 15 receives control instructions to proceed with the control actions in accordance with the signal transmitted from the connection port 17 and the driver port 121; the power supply 16 converts the external AC power (not shown in FIG) into proper DC power to the logic controller 15 and peripheral device 14; the connection port 17 is installed on the enclosure 11 of the base 10, when the tablet computer 20 connects to the connection port 17 of the base 10 via the connector 23, the tablet computer 20 is connected with the base 10, and controls and accesses the peripheral devices 14 (such as the hard disk drive inside the base 10) within the enclosure 11 of the base 10 by controlling the logic controller 15.

Referring to FIG. 1 and FIG. 2 again, the base 10 further consists a keyboard 18 and a touch control panel 19, the keyboard 18 and the touch control panel 19 are connected to the logic controller 15, when the tablet computer 20 is connected to the base 10, users can input instructions and data to the tablet computer 20 through the keyboard 18 and the touch control panel 19 of the base 10.

Referring to FIG. 1 and FIG. 2 again, when the tablet computer 20 is taken away from the base 10, the tablet computer 20 still functions by utilizing battery 24 or power supply 16 installed thereon, enabling users to input instructions and data on the screen 22 of the tablet computer 20 with the input pen 21. Therefore, the base 10 won't become idle after the tablet computer 20 is taken away, and the base 10 still functions as a peripheral hub.

While a preferred embodiment of the invention has been shown and described in detail, it will be readily understood and appreciated that numerous omissions, changes and additions may be made without departing from the spirit and scope of the invention.

1. An independent base of a tablet computer comprising:
an enclosure; and
a USB hub contains a driver port and a plurality of peripheral ports, said driver port is disposed on said enclosure, said peripheral ports are connected to various driver interfaces through cables, said driver interfaces are connected to different peripheral devices installed within said enclosure, enabling a computer to be connected to said driver port through a USB cable and to utilize said peripheral devices via said corresponding peripheral ports.

2. The independent base of a tablet computer recited in claim 1, wherein said USB hub consists a controller and a Repeater, said controller controls the protocol communication between said driver port and said peripheral ports, provides signals supporting hardware configuration, suspension and installation and offers interface registers for communicating with said computer.

3. The independent base of a tablet computer recited in claim 2, wherein said base further consists a logic controller, a power supply and a connection port connected to a tablet computer, said logic controller respectively links to said driver port, said Repeater and said connection port, said logic controller receives control instructions to proceed with control actions in accordance with signals transmitted from said connection port and said driver port, said power supply converts the external AC power into proper DC power to said logic controller and said peripheral devices, said connection port is installed on said enclosure, when a tablet computer connects to said connection port through said connector, said tablet computer can controls and accesses all said peripheral devices by controlling said logic controller.

4. The independent base of a tablet computer recited in claim 3, wherein said base consists a keyboard and a touch control panel, said keyboard and said touch control panel are connected to said logic controller for inputting instructions and data to said tablet computer.

5. The independent base of a tablet computer recited in claim 1, wherein said peripheral device includes hard disk drive, CD ROM or floppy disk drive.

6. The independent base of a tablet computer recited in claim 1, wherein said computer is a desk top computer.

7. The independent base of a tablet computer recited in claim 1, wherein said computer is a notebook computer.
